(19) United States
(12) Patent Application Publication
(10) Pub. No.: US 2008/0035241 A1
(43) Pub. Date: Feb. 14, 2008

(54) Multiple function liquid dispenser

(76) Inventor: Edward H. Wittbold, Boca Raton, FL (US)

Correspondence Address: Edward H. Wittbold, 19203 Skyridge Circle, Boca Raton, FL, 33498-6210, US

(21) Appl. No.: 11/888,603

(22) Filed: Aug. 1, 2007

Related U.S. Application Data
(60) Provisional application No. 60/837,479, filed on Aug. 14, 2006.

(51) Int. Cl. B67D 5/08

(52) U.S. Cl. 141/361; 119/75; 222/146.6; 222/52

(57) ABSTRACT

A water dispenser is adapted to provide water on demand to both humans and pets. An upper water dispenser provides water to humans and a lower water dispenser provides water to pets. The upper dispenser can be adapted for voice actuation. The lower water dispenser can be automatically actuated by a sensor which detects the presence of a pet and trigges release of water into a pet bowl.

### CROSS REFERENCE TO RELATED APPLICATION AND PRIORITY

This application claims the benefit and priority of application No. US 60/837,479 filed Aug. 14, 2006, entitled Human and Pet Water Cooler, which is incorporated by reference herein in its entirety.

### BACKGROUND OF THE INVENTION

1. Field of the Disclosure

The present disclosure relates in general to liquid dispensers and liquid coolers. The disclosure particularly relates to a water cooler adapted to dispense water to a human as well as to a pet, such as a dog or cat.

2. Description of Prior Developments

Water coolers are well known and in widespread use. Many accept a relatively large bottle or container of water and provide refrigeration to cool the water prior to dispensing it. Some provide a heater to heat the water prior to dispensing it. While a pet owner could fill a pet's drinking bowl from a conventional water cooler, this process can be awkward and inconvenient, and sanitation issues may arise when placing a pet bowl against a conventional water cooler dispenser.

It would be desirable to conveniently provide water to both humans and pets from a common water cooler without any sanitation issues and, in some embodiments, without the need for human intervention.

### SUMMARY

The present disclosure is directed to a free-standing or built-in water dispenser unit or water cooler which dispenses water and/or other liquids to both humans and animals in a safe, sanitary and convenient fashion. Bottled water or water from a household water line is distributed by the water cooler to a human water dispenser through one flow line and to an animal water dispenser through a separate flow line.

The water in each flow line can be cooled or chilled in a known fashion and the water in the flow line to the human water dispenser can also be heated in a known fashion. Voice-actuated, manually-actuated and/or electrically-actuated valves can be provided in each of the flow lines to the human water dispenser to allow a person to dispense the amount and type of water (hot or cold) into a container, such as a glass or cup by voice command, by manual operation or by electric power via push button operation.

A sensor, such as a motion detector or a proximity sensor, can be provided adjacent to the animal water dispenser to automatically dispense water into a removable water bowl. Another sensor, such as a weight sensor, float sensor or optical sensor, can be associated with the water bowl to prevent the bowl from being overfilled and to prevent the release of water from the animal water dispenser when the bowl is not properly positioned beneath the animal water dispenser. At the same time, a signal or alarm can be triggered to alert a pet owner in the event the pet bowl is not properly positioned or is missing.

A water filter can be disposed within the source of water or between the source of water and the respective human and animal dispensers to provide filtered water to both humans and animals. The filter can be located in a replaceable water bottle or downstream from the water bottle. Manual valves can be provided on each of the flow lines to the human dispenser to allow a person to control the exact type (hot or cold) and amount of water dispensed. A separate manual valve can also be provided on the flow line to the animal dispenser.

A pet can initiate the release of water from the pet dispenser by simply moving a paw adjacent to a motion or proximity sensor or by placing the pet's nose over or adjacent to the pet's water bowl to activate the sensor. A manual switch can be provided to turn off the motion sensor to allow for manual pet dispensing only by a human.

The pet's water bowl can be formed of a material either coated or impregnated with an antimicrobial agent such as an antimicrobial agent sold under the brand Agion. The bowl is adapted to be easily removed for cleaning.

The human water dispenser is located at a conventional height of several feet above the floor, while the pet or animal dispenser is located close to, on, or just above the floor. Voice activation allows for hands-free human operation to dispense water and the motion or proximity sensor provides for a fresh flowing supply of cool water each time a pet approaches the bowl and takes a drink. A manual switch can be provided to turn off the voice activation sensor to allow for manual human dispensing only. Optionally, this pet water dispenser can be operated by a voice command.

As noted above, a sensor, such as a weight sensor or optical sensor is provided under or adjacent to the pet bowl. This sensor provides a signal to disable a valve actuator controlled by the motion or proximity sensor in the event the pet bowl is missing or if it is full. The weight sensor or optical sensor prevents the release of water from the pet dispenser in the event the pet bowl is missing so as to prevent a water spill. This sensor also prevents the release of water from the pet dispenser in the event the pet's bowl is full of water, thereby preventing an overflow and water spill.

It can be appreciated that this dual purpose water delivery system provides a great deal of convenience to pet owners and ensures that pets are always provided a fresh supply of water. Because the water delivery to humans and pets can be provided over separate flow paths, there is no fluid communication between the human's water and the pet's water, as the water from the water jug or household water line flows independently through the respective delivery systems. This provides a clean, safe and sanitary delivery of water to both humans and animals.

In one embodiment, voice recognition technology can be integrated into the voice activation system, allowing a human to command, for example, “eight ounces cold” and receive eight ounces of cold water from the upper human dispenser upon a voice command, or “four ounces hot” and receive four ounces of hot water from the upper human dispenser. The voice commands can be received by a controller that opens an appropriate valve for a predetermined period of time corresponding to the amount of water identified in the voice command. The lower pet dispenser can be similarly controlled with a voice command exclusively for the pet dispenser, such as, “pet, four ounces”. This command will release four ounces of liquid through the lower dispenser.

The interaction between the pet proximity sensor, water delivery and the location or movement of the pet provides a positive feedback to the pet such that the pet quickly and easily learns how to release water into the pet bowl. This interaction also helps to increase the awareness of the pet and builds the pet's intelligence and aptitude.

The water cooler can be adapted to receive water directly from a household water line or from commercially available water jugs such as five gallon water jugs commonly used on conventional water coolers. Alternatively, a customized water container having any desired capacity can be provided on the upper portion of the water cooler.

For example, a smaller, easy-to-use three-gallon water tank can be used. A tank of this volume can be designed to easily fit in a standard kitchen sink for refilling. Handles can be molded into the water tank or separately mounted to the water tank to make the water tank easy to carry and easy to handle.

Added features include an LED or LCD display that includes a resettable clock or timer that provides an indication of the remaining useful life of the water filter or filters and provides standard date and time information. The display can also provide an indication when water is being heated and when water is being cooled in the respective heating and cooling units. An additional illuminated signal can provide notice that the pet's bowl is missing or out of proper position beneath its dispenser.

Night lights can be provided adjacent each dispenser to allow easy access to the dispenser in dim or dark lighting. For safety, a lock can be provided on the hot water dispenser to prevent inadvertent release of hot water.

The aforementioned objects, features and advantages will in part, be pointed out with particularity, and will, in part, become clear from the following more detailed description, taken in conjunction with the accompanying drawings, which form an integral part thereof.

### BRIEF DESCRIPTION OF THE DRAWINGS In the drawings:

FIG. 1 is a schematic perspective view of a water cooler constructed in accordance with a first embodiment of the water dispensing apparatus;

FIG. 2 is a perspective view of the water dispensing unit of FIG. 1 showing a dog using the lower dispenser;

FIG. 3 is a partial view of a dog activating the dispenser of FIG. 1;

FIG. 4 is a schematic perspective view of an alternate embodiment of the dispensing unit which includes voice actuation, a filter system, and a user display;

FIG. 5 is a perspective view of a dog using the water cooler of FIG. 4;

FIG. 6 is a partial view of a dog activating the dispenser of FIG. 4;

FIG. 7 is a schematic perspective view of a human operating the water cooler of FIG. 4 by voice command;

FIG. 8 is a partial enlarged perspective view of the upper or human dispenser portion of the water cooler of FIG. 7 showing the dispensing of water into a cup upon voice command;

FIG. 9 is a schematic diagram of a water distribution system adapted for use with the embodiment of FIG. 1; and

FIG. 10 is a view similar to FIG. 9 showing another embodiment of a water distribution system adapted for use with the embodiment of FIG. 4.

In the various views of the drawing, like reference numbers designate like or similar parts.

### DESCRIPTION OF THE REPRESENTATIVE EMBODIMENTS

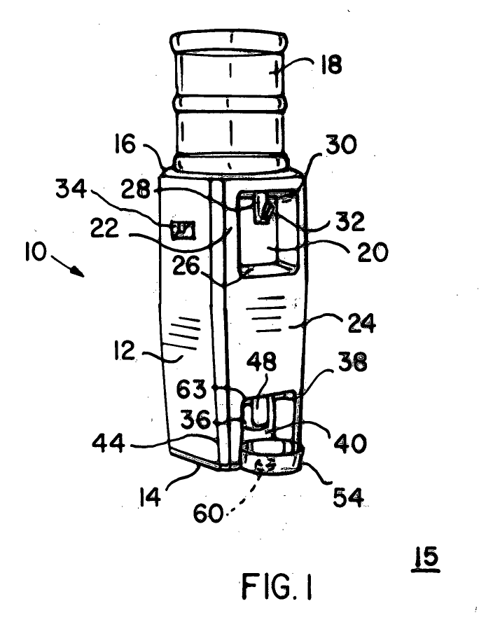

FIG. 1 shows a water or other liquid dispensing apparatus in the form of a water cooler 10. Water cooler 10 includes an upstanding or free-standing housing or body 12 having a flat bottom 14 adapted to rest on a support surface or floor 15.

Housing 12 further includes a top wall or roof 16 in which a recess is provided for receiving and supporting a source of liquid such as a container of water. The water container can be a bottle or jug, such as a conventional removable and replaceable five gallon water jug 18. An upper or first recess 20 is formed in the upper portion 22 of the front wall 24 of the housing 12. A horizontal support surface or shelf 26 borders the bottom of recess 20.

A user-actuated upper water dispenser or spigot 28 of known construction is provided on the upper wall 30 of recess 20 at a height of about two to four-and-one-half feet above the flat bottom 14 and floor 15. Spigot 28 can be provided on the back wall or any other convenient location on the water cooler 10. A manually-operated lever or tap 32 is provided on spigot 28 for allowing a person to dispense water from jug 18 through spigot 28 in a known manner. A similar manually-operated tap can be provided for manually dispensing water to a lower water dispenser, however, greater convenience can be achieved with an automatic lower water dispenser as discussed below.

A lower water dispenser or spigot 36 is provided, for example, on the upper wall 38 of a lower recess 40 formed in the lower portion 44 of the front wall 24 of the housing 12. Spigot 36 can be located from about one half inch to twelve inches above the flat bottom 14 and floor 15.. Recess 40 can be formed with or without a floor. Water dispenser 36 can include a sensor, such as a motion detector sensor or a proximity sensor 48, for sensing the immediate presence of an animal such as a household pet. Sensor 48 can, of course, be separated a distance apart from the dispenser 38.

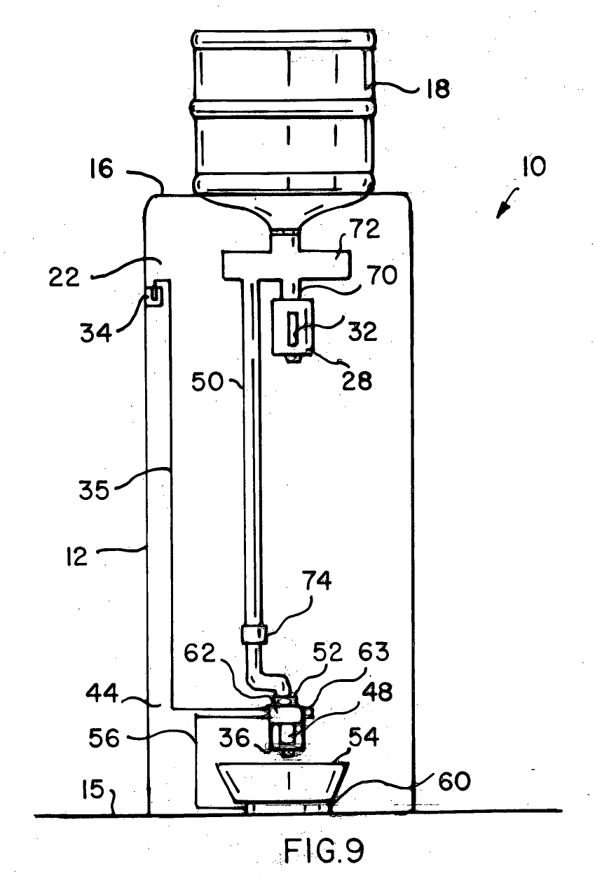

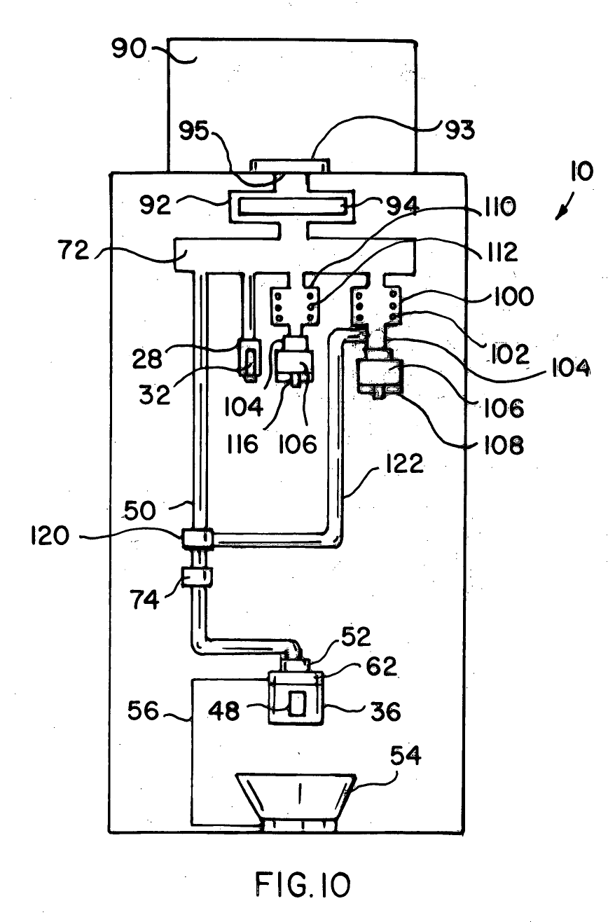

A water line 50 (FIG. 9), receiving water from the water jug 18, is connected to the lower water dispenser 36, as described more fully below. A valve 52 (FIG. 9) is provided in the lower water dispenser 36 to control the flow of water through the dispenser 36. Valve 52 is opened by a valve actuator 62 in response to a trigger signal from the sensor 48. The sensor 48 produces such a signal upon detecting the proximal or close presence or motion of a nearby object, such as the moving head or paw of a dog or a cat. Valve 52 can also be opened manually by actuation of tap 34 via power line 35.

When valve 52 is opened, fresh water flows into a water bowl 54 properly located within the lower recess 40. This actuation provides water upon demand to an animal. The amount of water dispensed is controlled by a sensor such as a weight senor 60, located directly below the lower water dispenser 36.

Alternatively, an optical sensor 63 on wall 38 can sense the level of water in the water bowl 54 and control valve 52 so that a predetermined level of water in bowl 54 causes sensor 53 to close valve 52. Alternatively, if the sensor 60 detects no weight or no bowl, meaning the bowl 54 is mispositioned or missing, sensor 60 sends a signal via signal line 56 to valve actuator 62, thereby preventing the opening of valve 52. This prevents the spillage of water onto floor 15. This same signal can be used to provide an indication to the pet owner that the bowl needs to be repositioned. This signal indicator can be an audible beep or an illuminated light. A simple microswitch actuated by contact with the bowl 54 can also be used to detect the presence of the bowl 54.

As further seen in FIG. 9, the water flow line 70 from water manifold 72 provides water from water jug 18 to the upper water dispenser 28. A separate water flow line 50 provides water from manifold 72 to the lower water dispenser 36. Normally-closed valve 52 isolates the water in flow line 50 from water bowl 54 and the pet drinking area around the lower recess 40

The vertical separation and air space between the lower dispenser 36 and the pet water bowl 54 further helps to isolate the lower dispenser 36 and flow line 50 from any contamination or communication with the water in water bowl 54. An optional one-way check valve 74 can be provided anywhere along flow line 50 for even greater isolation between flow lines 50 and 70 by preventing any back-flow into manifold 72.

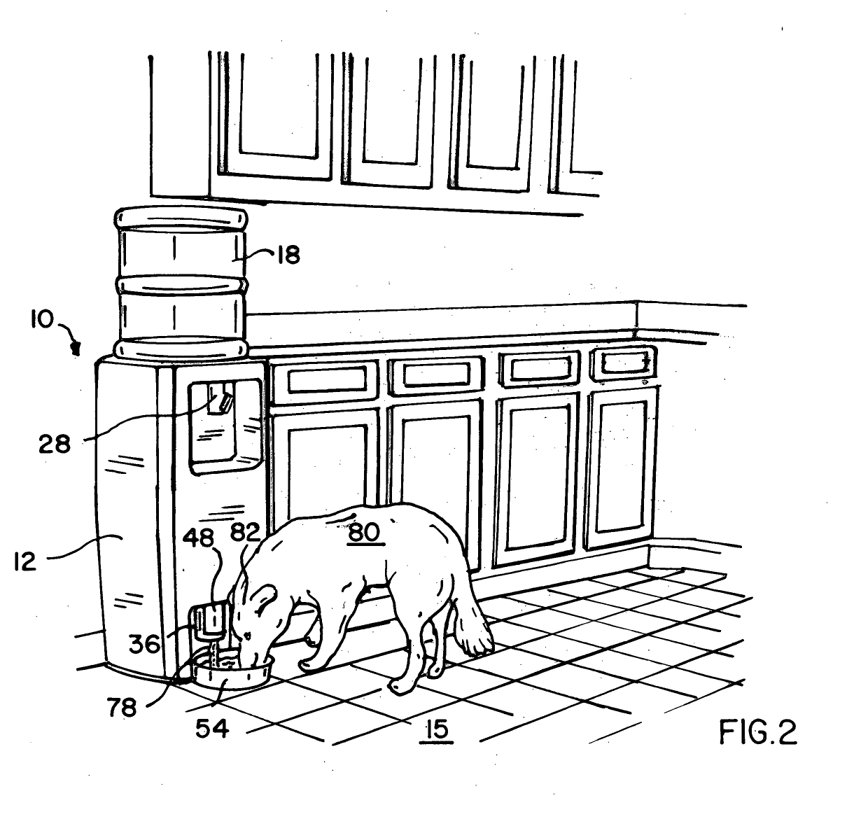

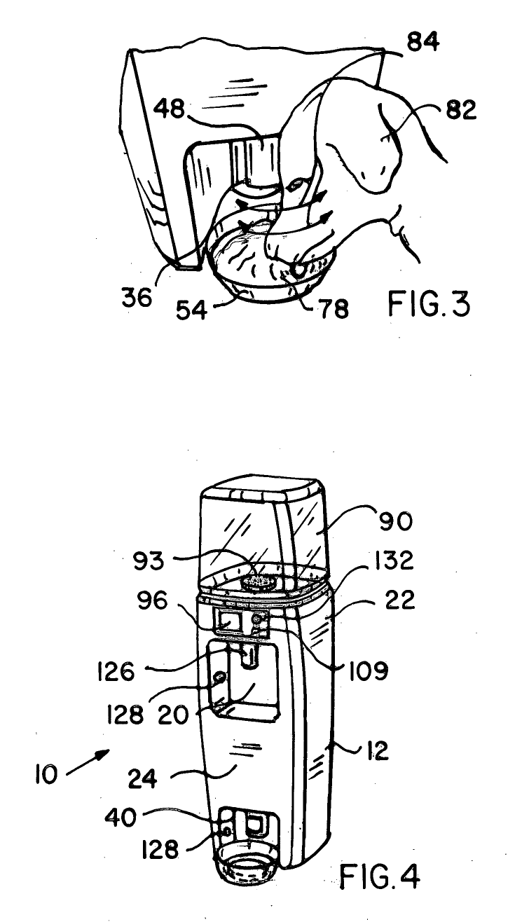

As seen in FIGS. 2 through 5, water 78 automatically flows into bowl 54 upon sensor 48 detecting the presence of an animal such as dog 80. The proximity sensor or optical sensor 48 detects the presence of dog 80 in FIG. 2. Alternatively, a motion sensor 48 can be used to detect movement of a dog's head 82 as represented by arrows 84 in FIG. 3, and in response cause the release of water.

Another embodiment of the invention is shown in FIG. 4, wherein a water dispenser unit in the form of water cooler 10 is shown provided with a customized removable water reservoir 90 that operates in the same manner as water jug 18. Water reservoir 90 can be fabricated in any convenient size to hold any amount of liquid, up to 2, 3, 4 or more gallons of water. Advantageously, the dimensions of reservoir 90 are selected to allow reservoir 90 to be easily placed beneath a standard kitchen water facet for filling with household tap water. Alternatively, an integral permanent or replaceable water filter 93 can be provided inside or in the exit port 95 of the reservoir 90.

In this case, when using tap water, it may be desirable to filter the tap water to remove impurities. A conventional filter unit 92 (FIG. 10) of known construction is provided with a filter 94 in the upper portion 22 of water cooler 10 to filter the water from reservoir 90 before the water is released through the upper and lower water dispensers 28, 36.

An LED or LCD display 96 is provided on the upper portion 22 of the front wall 24 to provide information to a user, as discussed below.

As further seen in FIG. 10, a conventional cooler such as a refrigeration or water cooling unit 100 with cooling coils 102 receives filtered water from manifold 72. A valve 104 can be manually-operated or user-operated by a voice or sound recognition actuator 106 to release chilled water through an upper cold water spigot 108 upon the actuator 106 receiving a recognizable voice or sound command. A control switch 109 (FIG. 4) can be provided to selectively enable and disable the voice actuator 106 so that only manual dispensing is possible, or is otherwise optional.

A water heating unit 110 of conventional design with heating coils 112 also receives filtered water from manifold 72. A valve 104 is operated by a voice or sound recognition actuator 106 to release heated water through an upper hot water spigot 116 upon receiving a recognizable voice or sound command. Actuator 106 can also be controlled by control switch 109.

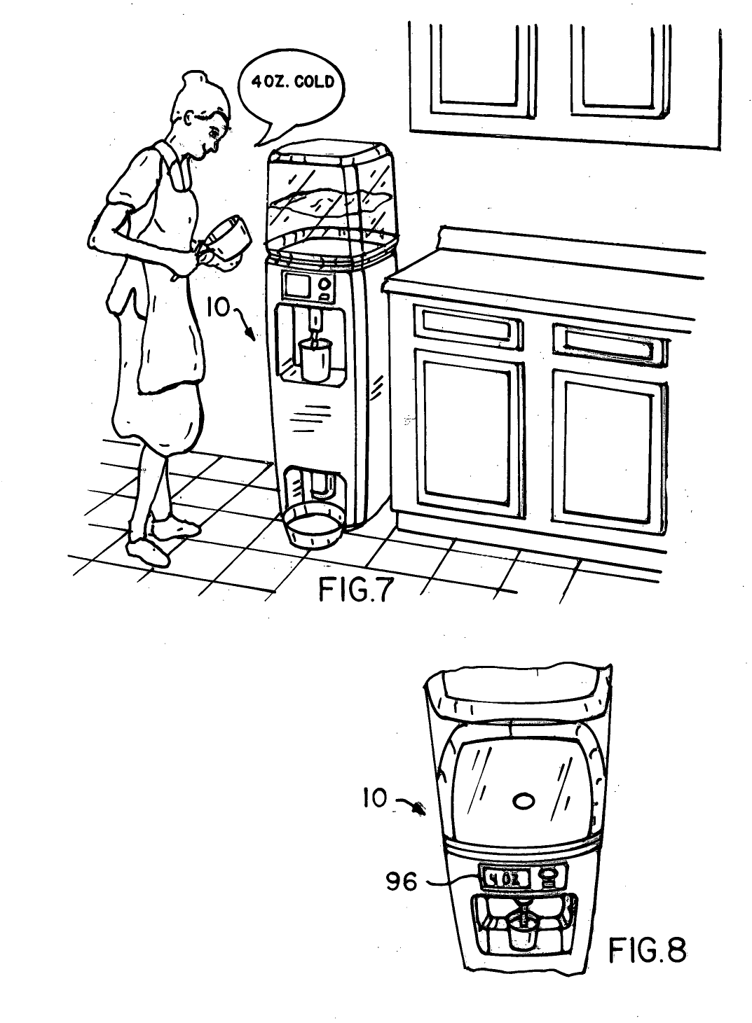

A manual spigot 28 with a manual tap 32 such as described above in connection with FIG. 1 also receives filtered water from manifold 72. A lower dispensing unit 36 also receives water either directly from manifold 72 or from the cooling unit 100. A user-operated valve 120 can be actuated to select room temperature water through flow line 50 or chilled water through flow line 12 for delivery to the lower animal dispensing unit 36. Use of voice activation is shown in FIG. 7 and the corresponding response of display 96 is shown in FIG. 8.

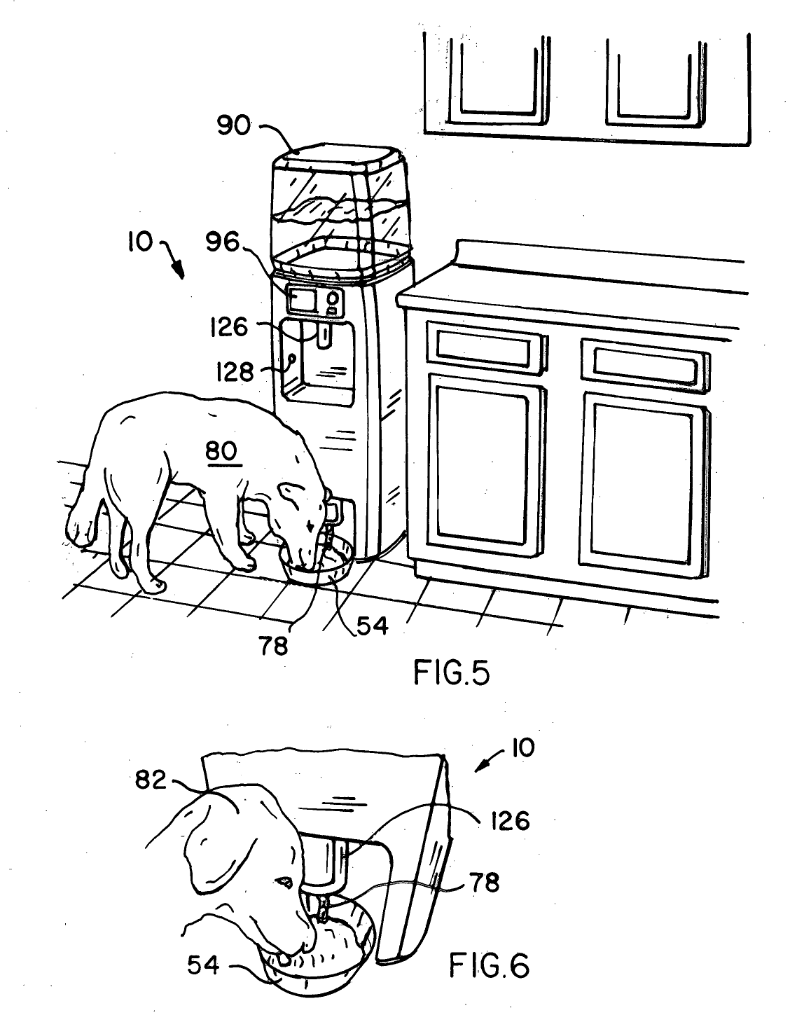

If desired, the output flow from each of the cold water spigot 108, hot water spigot 116 and room temperature spigot 28 can be directed to a common dispensing nozzle on housing 126, as seen in FIGS. 4, 5 and 6. As further seen in FIG. 4, a night light 128 can be provided adjacent to the upper and lower dispensing units, adjacent or within recesses 20, 40.

Display 96 can be adapted to provide various types of information to a user such as the type of water being dispensed (hot, cold or room temperature), the amount of water being dispensed such as 1, 2, 3, 4 etc. ounces, an indication, such as illuminated lights, when the heating unit 110 and/or cooling unit 100 are operating, and a date and time display.

An additional indicator such as an LED 132 (FIG. 4) can illuminate to provide notice that it is time to replace the removable water filter element 94 (FIG. 10). The water dispenser 110 can also include controls to adjust the temperature of the water dispensed from the hot and cold water spigots 116, 108. An additional LED indicator can also provide notice of a missing pet water bowl.

It is also possible to mount commercially available water filters directly to the hot and cold water spigots 116, 108, as well as to the spigots 28 and 36 in addition to or, as an alternative to, filter element 94.

There has been disclosed heretofore the best embodiment presently contemplated. Obviously, numerous modifications and variations are possible in light of the above teachings. It is therefore to be understood that within the scope of the appended claims, the disclosure may be practiced otherwise than as specifically described herein. For example, liquids other than water can be dispensed with the above-described dispensing system, and the system can be easily adapted to receive water from a public water source such as a household water line in addition to or in lieu of a water jug.

What is claimed is:

1. A liquid dispenser, comprising:
a housing having an upper portion and a lower portion;
at least one source of liquid;
a first dispenser provided on said upper portion of said housing and configured to dispense liquid from said at least one source of liquid; and
a second dispenser provided on said lower portion of said housing and configured to dispense liquid from said at least one source of liquid.

2. The liquid dispenser of claim 1, wherein said at least one source of liquid comprises a removable container.

3. The liquid dispenser of claim 1, wherein said housing comprises a bottom portion configured to rest on a support surface, and wherein said first dispenser is located at a height of two feet to four and one-half feet above the support surface and said second dispenser is located at a height of one-half inch to twelve inches above the support surface.

4. The liquid dispenser of claim 1, further comprising a first tap configured to dispense liquid from said first dispenser and a second tap configured to dispense liquid from said second dispenser.

5. The liquid dispenser of claim 1, wherein said first and second dispensers are configured for manual dispensing.

6. The liquid dispenser of claim 1, wherein said first dispenser comprises a voice actuator.

7. The liquid dispenser of claim 1, wherein said second dispenser comprises a sensor configured to sense the presence of an animal.

8. The dispenser of claim 1, further comprising a bowl located adjacent said second dispenser for receiving liquid therefrom.

9. A water dispensing apparatus comprising:
a housing having an upper portion and a lower portion;
a first water dispenser provided on said upper portion of said housing and configured to dispense water to a human; and
a second water dispenser provided on said lower portion of said housing and configured to dispense water to an animal.

10. The water dispensing apparatus of claim 9, further comprising a cooler disposed in said housing for cooling water.

11. The water dispensing apparatus of claim 9, further comprising a water source provided in said upper portion of said housing.

12. The water dispensing apparatus of claim 9, further comprising a water bowl located adjacent said second dispenser for receiving water therefrom.

13. The water dispensing apparatus of claim 12, further comprising a sensor electrically coupled to said second dispenser and configured to sense the presence of said bowl.

14. The water dispensing apparatus of claim 9, further comprising a sensor provided in said lower portion of said housing and configured to sense the presence of a pet and trigger the release water from said second water dispenser.

15. The water dispensing apparatus of claim 9, further comprising a water filter located in said upper portion of said housing.

16. The water dispensing apparatus of claim 9, further comprising a water manifold fluidly coupled to said first and second water dispensers.

17. The water dispensing apparatus of claim 9, further comprising a removable and replaceable water container supported on said upper portion of said housing and providing water to said first and second water dispensers.

18. A method of dispensing water to humans and animals from a common water source with a free-standing water dispensing unit, comprising:
providing a human-actuated water dispenser in an upper portion of said unit and dispensing water therefrom; and
providing a pet water dispenser in a lower portion of said unit and dispensing water therefrom.

19. The method of claim 18, further comprising detecting the presence of a pet and automatically dispensing water to said pet upon detecting the pet's presence.

20. The method of claim 18, further comprising detecting a human voice command and dispensing water to a human upon receiving said voice command.
